(19) United States
(12) Patent Application Publication
(10) Pub. No.: US 2026/0298529 A1
(43) Pub. Date: Oct. 1, 2026

(54) CYCLE GAS REFRIGERATOR AND LIQUEFACTION FACILITY

(71) Applicant: L'Air Liquide, Societe Anonyme pour l'Etude et l’Exploitation des Procedes Georges Claude, Paris (FR)

(72) Inventors: Pierre BARJHOUX, Sassenage (FR); Florian MARTIN, Sassenage (FR); Mathieu ROIG, Sassenage (FR); Franck DELCAYRE, Sassenage (FR)

(21) Appl. No.: 19/489,879

(22) PCT Filed: May 16, 2024
(86) PCT No.: PCT/EP2024/063572

§ 371 Date: Dec. 3, 2025

(30) Foreign Application Priority Data
Jun. 7, 2023 (FR) FR2305700

(51) Int. Cl. F25J 1/00; F25J 1/02

(52) U.S. Cl. CPC F25J 1/001; F25J 1/0254; F25J 1/0257; F25J 1/0294

(57) ABSTRACT

The invention relates to a cryogenic refrigerator which has a cycle circuit comprising a compression mechanism with at least three rotary compressors arranged in parallel and mounted respectively on three rotary shafts, at least two of the rotary shafts being respectively coupled to turbines, at least one motor for driving at least one of the rotary shafts, at least the two parallel-connected compressors coupled to a turbine are each associated with a respective member for measuring the flow rate passing through the compressor in question and with a respective member for regulating the flow rate admitted to the compressor, the coupled turbines each comprising a respective sensor for measuring the rotational speed of the turbine and a respective system for controlling the rotational speed of the turbine, the refrigerator comprising a control member which comprises a microprocessor and is configured to receive measurements from the members for measuring the flow rate and from the sensors for measuring the speed and to command the members for regulating the flow rate.

### CROSS REFERENCE TO RELATED APPLICATIONS

This application is a § 371 of International PCT Application PCT/EP2024/063572, filed May 16, 2024, which claims the benefit of FR2305700, filed Jun. 7, 2023, both of which are herein incorporated by reference in their entireties.

### FIELD OF THE INVENTION

The invention relates to a cycle gas refrigerator and to a liquefaction facility.

### BACKGROUND OF THE INVENTION

One important aspect of hydrogen and/or helium refrigerators/liquefiers is to minimize energy consumption. One of the ways of reducing this consumption is to recover the energy of expansion of the cycle gas to compress this cycle gas via a machine referred to as a “turbo-booster” (i.e. a “turbo-compressor”, that is to say a combination of a turbine and a compressor). Cf. for example US2015168057A or WO2009130466A. Turbo-compressors make it possible both to reduce the consumption of electrical energy input into the cycle and to reduce the size of the cycle compressor.

Turbo-compressors can be positioned upstream or downstream of a cycle compressor depending on the process conditions. This arrangement is found most frequently in cycles. Indeed, this arrangement is the simplest one for controlling the process because each compressor is independent of the others. This series-connected configuration is made possible by operating conditions that promote highly efficient compression and suitable working fluids.

The turbo-compressor function involves matching the parameters of the expanded fluid to the compressed fluid so that both functions are implemented with the greatest possible efficiency.

The turbo-compressors must also be able to operate through all of the configurations with which the refrigerator/liquefier is faced. The operating parameters of the turbo-compressor can restrict the possible arrangements of turbines, making the process less efficient or more complex.

In the case of parallel-connected turbo-compressors, these compressors will achieve the same compression rate. The variation in power of one turbine will then directly affect the other turbo-compressors and therefore affect the efficiency and operability of the entire refrigerator.

### SUMMARY OF THE INVENTION

One aim of the present invention is to overcome all or some of the abovementioned drawbacks of the prior art.

For this purpose, the refrigerator according to the invention, which is also in accordance with the generic definition thereof in the preamble above, is configured such that it comprises at least one motor for driving at least one of the rotary shafts bearing a turbine and a compressor and in that at least the two parallel-connected compressors coupled to a turbine are each associated with a respective member for measuring the flow rate passing through the compressor in question and with a respective member for regulating the flow rate admitted to the compressor, for example one or more upstream or downstream movable guide members such as an “IGV”, the at least two turbines coupled to the compressors each comprising a respective sensor for measuring the rotational speed of the turbine and a respective system for controlling the rotational speed of the turbine, the refrigerator comprising an electronic control and command member which comprises a microprocessor and is configured to receive measurements from the members for measuring the flow rate and from the sensors for measuring the speed and to command the members for regulating the flow rate.

In another embodiment, the invention relates more particularly to a cycle gas refrigerator comprising a cycle circuit containing a cycle gas comprising at least one of the following: nitrogen, helium, hydrogen, the cycle circuit being configured to subject the cycle fluid to a thermodynamic cycle that brings the cycle fluid to a given cryogenic temperature at least at one end of the cycle circuit, the cycle circuit comprising a mechanism for compressing the cycle fluid, a mechanism for cooling the cycle fluid, and a mechanism for expanding the cycle fluid, wherein the mechanism for expanding the cycle fluid comprises at least two turbines rotatably mounted on respective rotary shafts, the compression mechanism comprising at least three rotary compressors arranged in parallel in the cycle circuit and mounted respectively on three rotary shafts, at least two of the rotary shafts being respectively coupled to the turbines so as to recover work of expansion of the cycle fluid for compressing the cycle fluid.

According to the proposed solution, the refrigerator utilizes at least one motor-turbo-compressor (instead of the turbo-compressor described above) in order to bring about this active control between parallel-coupled compressors by adjusting the electrical power fed to the motor. This control could be implemented by a variator which varies the rotational frequency of said one or more electric motors.

Although the addition of one or more motors increases the capital costs of the hardware of the refrigerator, it makes it possible to control the rotational frequency of the motor to improve the efficiency of expansion of the turbines and/or the efficiency of parallel compression and the compression power. That is to say, compared with the prior art, it is thus possible to increase the outlet pressure in relation to a conventional turbo-booster, or it is possible to reduce the size of the cycle compressor.

Providing at least one motor makes it possible to control the rotational speed of the corresponding impellers (compressor and turbine) and to stabilize the operation of the one or more coupled compressor and turbine assemblies, in particular if several of them are installed in parallel. Indeed, in the case of a parallel arrangement, it takes less of a disruption to destabilize the assembly and cause it to operate non-optimally. This may even lead to making one of the compressors operate in an unsafe operating area, such as the pumping area. This drawback is eliminated or alleviated by the one or more motors. This also makes it possible to optimize the operating point of the machines (compressors/turbines).

In addition, embodiments of the invention may have one or more of the following features:
the parallel-connected compressors are identical, the electronic control and command member being configured to apply a set value for the flow rate admitted to the compressors which is identical for all of the parallel-connected compressors,
the electronic control and command member is configured to apply an identical set value for the rotational speed of the turbines coupled to the compressors,
the member for regulating the flow rate admitted to the compressor comprises at least one of the following: one or more movable guide members, an upstream inlet guide vane “IGV”, a variable-vane diffuser downstream of the impeller of the compressor, a system for bypassing the compressor,
the refrigerator has a member for regulating the flow rate admitted to the compressor that is shared by at least several of the parallel-connected compressors,
the system for controlling the rotational speed of the turbine comprises at least one of the following: an inlet guide vane “IGV”, a throttling valve, a system for bypassing the turbine,
the refrigerator comprises three or more drive motors configured to respectively drive the three rotary shafts of the three rotary compressors arranged in parallel in the cycle circuit,
the electronic control and command member is configured to manage the speeds of the one or more motors,
the one or more motors are electric motors and the electronic control and command member is configured to command the rotational speed of the one or more motors so as to achieve the same compression rate in each compressor.

The invention also relates to a facility for liquefying a stream of feed gas, comprising a feed pipe configured to be connected to a source of feed gas to be liquefied, for example hydrogen, a set of heat exchangers exchanging heat with the stream of feed gas carried by the feed pipe, the facility comprising a refrigerator which exchanges heat with the set of heat exchangers and is configured to cool the stream of feed gas, the refrigerator being in accordance with any one of the features mentioned above or below.

The invention may also relate to any alternative device or method comprising any combination of the features mentioned above or below within the scope of the claims.

Other particular features and advantages will become apparent upon reading the following description, which is provided with reference to the figures.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments. The invention will be better understood on reading the following description provided purely by way of example and with reference to the appended drawings, in which:

FIG. 1 is a schematic and partial view of one example of the structure and operation of a liquefaction facility comprising an exemplary refrigerator according to the invention.

FIG. 2 is a schematic and partial view illustrating one example of the operation of an electronic control and command member of the refrigerator.

### DETAILED DESCRIPTION OF THE INVENTION

Throughout the figures, the same reference signs relate to the same elements.

In this detailed description, the following embodiments are examples. Although the description refers to one or more embodiments, this does not mean that the features apply only to a single embodiment. Individual features of different embodiments can also be combined and/or interchanged in order to provide other embodiments.

The cycle gas refrigerator 2 illustrated comprises a cycle circuit 3 containing a cycle gas comprising at least one of the following: nitrogen, helium, hydrogen.

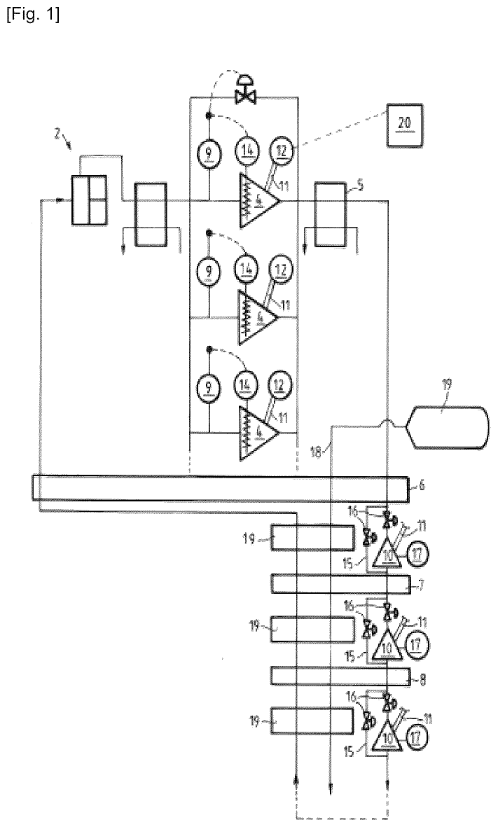

The cycle circuit 3 is configured to subject the cycle fluid to a thermodynamic cycle that brings the cycle fluid to a given cryogenic temperature at least at one end of the cycle circuit 3. As illustrated in FIG. 1, this cold power that is generated can be utilized to cool a stream 18 of feed gas such as hydrogen, for example via a set of heat exchangers 19. The stream of feed gas can be supplied to a first end of a feed pipe 18 by a source 19. A second end of the feed pipe may be connected to a store that recovers cooled (liquefied) feed gas.

In another variant (not shown), the cold power that is generated can be utilized to liquefy the cycle gas itself, which can be recovered.

The cycle circuit 3 comprises the following, preferably disposed in series in the cycle circuit 3: a mechanism 4 for compressing the cycle fluid, a system 5, 6, 7, 8 for cooling the cycle fluid, a mechanism 10 for expanding the cycle fluid and a system for heating the cycle fluid.

The mechanism 10 for expanding the cycle fluid comprises at least two turbines 10 rotatably mounted on respective rotary shafts 11, preferably arranged in series in the cycle circuit 3.

The compression mechanism comprises at least three rotary compressors 4 arranged in parallel in the cycle circuit 3 and mounted respectively on three rotary shafts. At least two of the rotary shafts of the compressors 4 are respectively coupled to the turbines 10 so as to recover work of expansion of the cycle fluid for compressing the cycle fluid. The system for cooling the cycle gas and the system for heating the cycle gas may comprise one or more heat exchangers, in particular one or more countercurrent heat exchangers that exchange heat between relatively cold and hot streams of the cycle.

In addition, the refrigerator 2 comprises at least one motor 12 for driving at least one of the rotary shafts 11 bearing a turbine 10 and a compressor 4. That is to say, at least one of the pairs composed of a compressor coupled to a turbine (turbo-compressor) is a motor-turbo-compressor.

In addition, at least the two parallel-connected compressors 4 coupled to a turbine 11 are each associated with a respective member 9 for measuring the flow rate passing through the compressor 4 in question (for example a flow meter) and with a respective member 14 for regulating the flow rate admitted to the compressor 4.

The respective member 14 for regulating the flow rate admitted to the compressor 4 is for example one or more upstream and/or downstream movable guide members such as an “IGV” (Inlet Guide Vane). In a variant or in combination, the respective member 14 for regulating the flow rate admitted to the compressor 4 may be a bypass (controlled deflection of the stream feeding the compressor or compression stage in question).

In addition, the turbines 10 coupled to the compressors 4 preferably each comprise a respective sensor 17 for measuring the rotational speed of the turbine 10 and a respective system 15, 16 for controlling the rotational speed of the turbine 10.

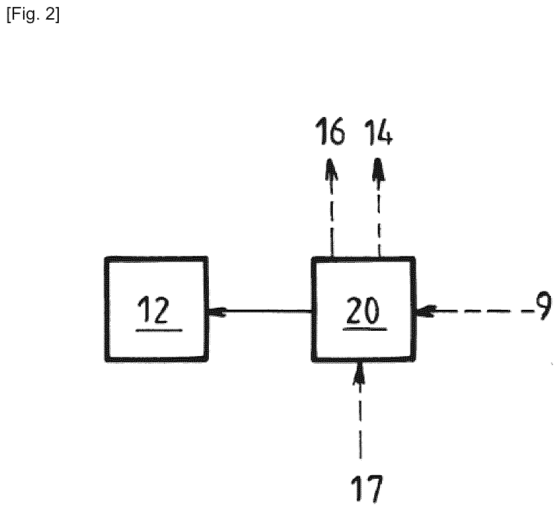

The refrigerator 1 comprises an electronic control and command member 20 which comprises a microprocessor and is configured to receive measurements from the members 9 for measuring the flow rate and from the sensors 17 for measuring the speed and to command the members 14, 16 for regulating the flow rate and/or one or more motors 12. Cf. FIG. 2.

This allows the flow rate of the cycle gas to be controlled in the parallel-connected compressors 4. This makes it possible to apply a set value for the flow rate in one of the compressors 4 and to copy the same set value for the other parallel-connected compressors 4 (all of the compression stages can consist of parallel-mounted compressors).

The flow rate can be controlled by an external actuator, for example an “IGV” upstream of the compressor, an “IGV” downstream of the compressor, a controlled-vane diffuser, a pipe and a valve for bypassing the compressor 4.

A member 14 for regulating the flow rate admitted may be shared by several of the parallel-connected compressors.

The system 15, 16 for controlling the rotational speed of the turbine 10 may have for example: an “IGV” which may be variable at the inlet and/or a throttling valve and/or a valve for bypassing the turbine. This system for controlling the speed can regulate a rotational speed which is preferably the same target for each machine.

This makes it possible to define speed adjustment parameters for each turbo-compressor assembly. This makes it possible for example to offset the speeds of the turbo-compressors with respect to a set value if unsuitable behavior is observed (for example pressure oscillation, unstable hydraulic behavior, pumping of a compressor, etc.).

The use of at least one motor to drive a compressor parallel-coupled to a turbine of the assemblies makes it possible to control the rotational speed of the assembly of compressor(s)/turbine(s), irrespective of the operating conditions around the turbine and the compressor. The power of the motor can be adapted on the basis of the power of the turbine and the power required by the compressor. This makes it possible to stabilize the operation of rotary machines (compressors/turbines). This is particularly advantageous in relation to a parallel arrangement of turbo-compressors (without motors), which can rapidly be destabilized. The proposed arrangement also makes it possible to adjust the rotational speed so as to optimize the operation of the machines. In addition, the one or more motors make it possible to increase the power of the compressor in question in relation to the power of the associated turbine. This affords better operation (depending on the configuration of the cycle).

The flow rate of gas through each turbine can be determined by the guide-vane geometry of the latter, unless a regulation system (for example IGV/expansion valve upstream of the apparatus) can adjust it to a certain extent.

The total flow in the cycle can be determined by the flow in the turbines (with possibly also in addition an optional flow sent to a cold end of the cycle). This total flow is compressed in the compression mechanism. This total flow can be distributed between parallel-connected compressors either passively (typically via a very similar hydraulic circuit) or “actively” (for example via an IGV, throttling valve, etc.). Finally, the entire flow of cycle gas is compressed.

Preferably, the fluidic circuit leading to each compressor is configured to have the same characteristics in terms of a pressure drop in particular (reproduction of obstacles for the gas: same number of bends/developed lengths of pipes, etc.).

This configuration is particularly advantageous or efficient when the speeds of the compressors/turbines and the mechanical powers of the compressors are identical for each compressor.

The mechanical power of the compressor is for example either:
that of the coupled turbine in the case of a turbo-compressor, or
that of the turbine supplemented by/added to that of the motor in the case of a motor-turbo-compressor.

Because the power of the motor is equal to the power of the compressor minus the power of the turbine, if all of the compressors and all of the turbines have the same power, the motors will supply the same power. The configuration can also be advantageous when the compressors are managed with different speeds but compressor diameters (impeller diameter) that are adjusted to provide the optimum compression rate. In the example illustrated, the cycle circuit comprises three drive motors 12 configured to respectively drive three rotary shafts 11 of three rotary compressors 4 arranged in parallel in the cycle circuit 3. The three parallel-connected compressors 4 are respectively coupled to three turbines 11.

Of course, this configuration is not limiting. Thus, it is possible to envisage any other configuration, for example: more than two compressors, turbines connected in series and/or in parallel (the architecture being adapted to balance the powers of the turbines on each of the shafts that connect them to the compressors). For example, at least one impeller (compressor/turbine) is arranged at each end of the drive shaft of the motor. There are preferably more than two motors driving the compressors. The parallel-connected compressors 4 have identical pressure differentials (between their inlet and outlet). However, the flow rates within these parallel-connected compressors 4 can fluctuate and be different. This can cause problems and instabilities when the parallel-connected compressors 4 are identical.

The control described above makes it possible to correct this problem. The control also makes it possible to regulate the rotational speed of the coupled turbines 10 at a given operating point, in particular the optimum operating point of the turbine, i.e. to its maximum output.

The electronic control and command member 20 can be configured to also manage the speeds of the one or more motors 12 of the parallel-connected motor-turbo-compressors, for example via a frequency variator (electric motor). This speed of the motors makes it possible to align the optimum operating point of the turbines and compressors.

The electronic control and command member 20 may be configured to apply an identical set value for the rotational speed of the turbines 10 coupled to the compressors 4.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-9. (canceled)

10. A cycle gas refrigerator comprising:
a cycle circuit containing a cycle gas comprising at least one of the following: nitrogen, helium, and hydrogen, the cycle circuit being configured to subject the cycle fluid to a thermodynamic cycle that brings the cycle fluid to a given cryogenic temperature at least at one end of the cycle circuit, the cycle circuit comprising:
a compression mechanism configured to compress the cycle fluid;
a cooling mechanism configured to cool the cycle fluid; and
an expansion mechanism configured to expand the cycle fluid, wherein the expansion mechanism of the cycle fluid comprises at least two turbines rotatably mounted on respective rotary shafts, the compression mechanism comprising at least three rotary compressors arranged in parallel in the cycle circuit and mounted respectively on three rotary shafts, at least two of the rotary shafts being respectively coupled to one of the two turbines, respectively, so as to recover work of expansion of the cycle fluid for compressing the cycle fluid,
at least one motor configured to drive at least one of the rotary shafts bearing a turbine and a compressor and in that at least the two parallel-connected compressors coupled to a turbine are each associated with a respective flow measuring member configured to measure a flow rate passing through the respective compressor and with a respective regulating member configured to regulate the flow rate admitted to the compressor,
wherein the at least two turbines coupled to the compressors each comprise a respective sensor configured to measure a rotational speed of the turbine and a respective controlling system configured to control the rotational speed of the respective turbine, an electronic control and command member which comprises a microprocessor and is configured to receive measurements from the measurement members configured to measure the flow rate and from the sensors configured to measure the speed and to command the regulating members configured to regulate the flow rate, and
wherein the parallel-connected compressors are identical,
wherein the electronic control and command member is configured to apply a set value for the flow rate admitted to the compressors which is identical for all of the parallel-connected compressors.

11. The refrigerator as claimed in claim 10, wherein the electronic control and command member is configured to apply an identical set value for the rotational speed of the turbines coupled to the compressors.

12. The refrigerator as claimed in claim 10, wherein the member for regulating the flow rate admitted to the compressor comprises at least one of the following: one or more movable guide members, an upstream inlet guide vane “IGV”, a variable-vane diffuser downstream of the impeller of the compressor, a system for bypassing the compressor.

13. The refrigerator as claimed in claim 10, wherein the regulation member is shared by at least several of the parallel-connected compressors.

14. The refrigerator as claimed in claim 10, wherein the system for controlling the rotational speed of the turbine comprises at least one of the following: an inlet guide vane “IGV”, a throttling valve, and a system for bypassing the turbine.

15. The refrigerator as claimed in claim 10, further comprising three or more drive motors configured to respectively drive the three rotary shafts of the three rotary compressors arranged in parallel in the cycle circuit.

16. The refrigerator as claimed in claim 10, wherein the electronic control and command member is configured to manage the speeds of the one or more motors.

17. The refrigerator as claimed in claim 16, wherein the one or more motors are electric motors and the electronic control and command member is configured to command the rotational speed of the one or more motors so as to achieve the same compression rate in each compressor.

18. A facility for liquefying a stream of feed gas, comprising a feed pipe configured to be connected to a source of feed gas of hydrogen to be liquefied, a set of heat exchangers exchanging heat with the stream of feed gas carried by the feed pipe, the facility comprising a refrigerator which exchanges heat with the set of heat exchangers and is configured to cool the stream of feed gas, wherein the refrigerator is in accordance with that of claim 10.
